(19) United States
(12) Patent Application Publication
(10) Pub. No.: US 2014/0060870 A1
(43) Pub. Date: Mar. 6, 2014

(54) MULTIPURPOSE GARDEN TOOL

(71) Applicant: John G. Scarpati, Trenton, NJ (US)

(72) Inventor: John G. Scarpati, Trenton, NJ (US)

(21) Appl. No.: 13/952,515

(22) Filed: Jul. 26, 2013

Related U.S. Application Data
(60) Provisional application No. 61/676,319, filed on Jul. 26, 2012.

(51) Int. Cl. A01B 1/20

(52) U.S. Cl. CPC A01B 1/20
USPC 172/379

(57) ABSTRACT

A gardening tool can take the place of multiple gardening tools. The gardening tool includes a substantially flat elongated plane having three edges that are adapted to function as different working tools. The gardening tool may be attached to a handle for operation.

### CROSS-REFERENCE TO RELATED APPLICATION

This application claims the benefit of priority of U.S. provisional application No. 61/676,319, filed Jul. 26, 2012, the contents of which are herein incorporated by reference.

### BACKGROUND OF THE INVENTION

The present invention relates to agricultural equipment and, more particularly, to gardening tools.

Typically, several specialized tools may be used in the processes of cultivating plants, such as a hoe, a rake, a grading tool and many others. These various tools must be gathered up and transported to a site a gardener plans to work in.

As can be seen, there is a need for a multifunctional tool that can perform more than one plant cultivating function and reduce the organization and labor presently used in carrying a bundle of gardening tools to a worksite.

### SUMMARY OF THE INVENTION

In one aspect of the present invention, a gardening tool comprises an elongated plate having first and second long sides and first and second short sides, the elongated plate having a rake side formed along the first long side, the rake side having a plurality of rounded prongs extending therefrom; a grading side formed along the second long side, opposite the first long side, the grading side having a flat grading side edge for grading; a cultivator side along the first short side, disposed between the first and second long sides, the cultivator side having a plurality of sharp prongs extending therefrom; and a hoe side along the second short side, opposite the cultivator side, the hoe side having a flat outer short side edge.

In another aspect of the present invention, a gardening tool comprises an elongated plate having first and second long sides and first and second short sides, the elongated plate having a rake side formed along the first long side, the rake side having a plurality of rounded prongs extending therefrom; a grading side formed along the second long side, opposite the first long side, the grading side having a flat grading side edge for grading; a cultivator side along the first short side, disposed between the first and second long sides, the cultivator side having a plurality of sharp prongs extending therefrom; a hoe side along the second short side, opposite the cultivator side, the hoe side having a flat outer short side edge; and an attachment stem extending from a face of the elongated plate; and a handle disposed on the attachment stem, wherein the elongated plate is curved at a rake side thereof.

These and other features, aspects and advantages of the present invention will become better understood with reference to the following drawings, description and claims.

### BRIEF DESCRIPTION OF THE DRAWINGS

FIG. 1 is a perspective view of a garden tool according to an exemplary embodiment of the present invention;

FIG. 2 is a perspective view of the tool head of the garden tool of FIG. 1;

FIG. 3 is a top view of the tool head of FIG. 2; and

FIG. 4 is a side view of the tool head of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a gardening tool that can take the place of multiple gardening tools. The gardening tool includes a substantially flat elongated plane having three edges that are adapted to function as different working tools. The gardening tool may be attached to a handle for operation.

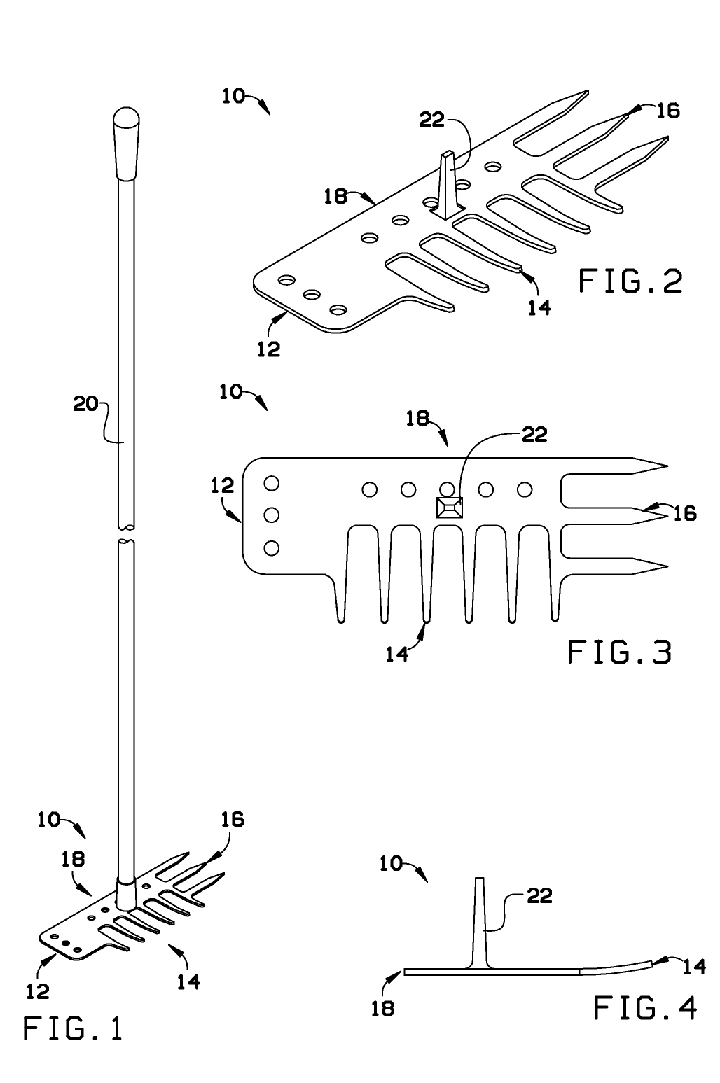

Referring now to FIGS. 1 through 4, a multipurpose gardening tool can include a working part 10 (also referred to as tool 10) and a handle 20. The working part (as shown in FIGS. 2 through 4) of the tool 10 may be made of a rigid material, such as a metal, and have shape of an elongated rectangular plate having a length greater than its width, for example, having the approximate dimensions of the useful end of a common garden rake or cultivating tool.

A rake side 14 of the tool 10, which may be designated as the forward edge, may have an upward pitch as shown in FIG. 4, while a grading side 18, also referred to as the rearward edge, may be flat with no upward pitch. The central portion of the rake side 14 can include a series of, for example, from four to six, typically five evenly spaced fingers with rounded tips.

A cultivator side 16 of the tool 10 can include a series of, for example, three, evenly spaced fingers with pointed tips. A hoe side 12, opposite the cultivator side 16 of the tool 10, can include a blade whose borders are the end of the tool 10. The long forward edge (rake side 14) of the tool 10 lying between the cultivator side 16 of the tool 10 and the hoe side 12 of the tool.

An attachment stem 22 can be provided for attaching the tool 10 to a handle 20. The attachment stem 22 may be placed centrally along the rearward edge (grading side 18) of the tool 10 and set inward from the edge. The attachment stem 22 may be a spike adapted to penetrate the end of, for example, a wood pole and fastened into place with a screw (not shown). Alternatively, the attachment stem 22 can be replaced with any device that can be adapted to mate with a complementary device set into the handle 20.

The row of rounded fingers along the central portion of the forward edge (rake side 14) of the tool 10 may be used as a rake when that edge of the tool faces the ground. Similarly, the row of pointed fingers on one end (cultivator side 16) of the tool 10 may be used as a cultivator when the tool is rotated to place the fingers on the ground, and the blade on the other end (hoe side 12) of the tool may be used as a hoe when the tool may be rotated to place the blade on the ground. The rear edge (grading side 18) of the tool 10 may be used as a grader when that edge of the tool may be placed on the ground.

The gardening tool of the present combines the functions of four separate gardening tools into one tool without requiring a change of components or addition of attachments to change function. The gardening tool may be able to change quickly and easily to function either as a hoe, a rake, a grader and a cultivator. By enabling one tool to do the work of four different tools without a change of components, the tool load for a gardener may be lighter, and his work tool more convenient to use.

The gardening tool may be made of metal that can be molded or stamped to the shape required to make the four-sided tool, each side having the described function, as known to those skilled in the tool making arts. The handle may be made in a similar manner from either natural or synthetic material. The two parts may then be attached to one another to make the finished tool.

The design and function of gardening tool may be altered by substituting the thickness or weight of the metal used to make the tool, the length of the handle, or by changing the functions of the four sides of the tool.

It should be understood, of course, that the foregoing relates to exemplary embodiments of the invention and that modifications may be made without departing from the spirit and scope of the invention as set forth in the following claims.

What is claimed is:

1. A gardening tool comprising:
an elongated plate having first and second long sides and first and second short sides, the elongated plate having:
a rake side formed along the first long side, the rake side having a plurality of rounded prongs extending therefrom;
a grading side formed along the second long side, opposite the first long side, the grading side having a flat grading side edge for grading;
a cultivator side along the first short side, disposed between the first and second long sides, the cultivator side having a plurality of sharp prongs extending therefrom; and
a hoe side along the second short side, opposite the cultivator side, the hoe side having a flat outer short side edge.

2. The gardening tool of claim 1, further comprising a handle attached to the elongated plate.

3. The gardening tool of claim 1, wherein the plurality of sharp prongs includes three sharp prongs.

4. The gardening tool of claim 1, wherein the plurality of rounded prongs includes from four to six rounded prongs.

5. The gardening tool of claim 1, further comprising an attachment stem extending from a face of the elongated plate.

6. The gardening tool of claim 1, further comprising a handle disposed on the attachment stem.

7. The gardening tool of claim 1, wherein the elongated plate is curved at a rake side thereof.

8. A gardening tool comprising:
an elongated plate having first and second long sides and first and second short sides, the elongated plate having:
a rake side formed along the first long side, the rake side having a plurality of rounded prongs extending therefrom;
a grading side formed along the second long side, opposite the first long side, the grading side having a flat grading side edge for grading;
a cultivator side along the first short side, disposed between the first and second long sides, the cultivator side having a plurality of sharp prongs extending therefrom;
a hoe side along the second short side, opposite the cultivator side, the hoe side having a flat outer short side edge; and
an attachment stem extending from a face of the elongated plate; and
a handle disposed on the attachment stem,
wherein the elongated plate is curved at a rake side thereof.

9. The gardening tool of claim 8, wherein the plurality of sharp prongs includes three sharp prongs.

10. The gardening tool of claim 8, wherein the plurality of rounded prongs includes from four to six rounded prongs.
